(19) United States
(12) Patent Application Publication
(10) Pub. No.: US 2009/0064264 A1
(43) Pub. Date: Mar. 5, 2009

(54) Broadcast receiving apparatus and method, method and storage medium for inhibiting receiving

(75) Inventor: Hiroyuki Taguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/216,251

(22) Filed: Jul. 1, 2008

(30) Foreign Application Priority Data
Aug. 30, 2007 (JP) 2007-223451

(51) Int. Cl. H04N 7/173

(52) U.S. Cl. 725/131

(57) ABSTRACT

A broadcast receiving apparatus and method capable of setting a receiving reservation at one time for a program shown several times. The broadcast receiving apparatus includes a keyword holding unit which holds a keyword to determine whether a program is desired to be received by the user, a program information obtaining unit which obtains program information of each broadcast before respective broadcasts of a plurality of broadcast programs for which the receiving reservation is performed are received, a determining unit which determines whether the program information of the respective broadcasts obtained includes the keyword, and an inhibiting unit which inhibits the reception of the respective broadcasts when determining that the keyword is included in the program information of the respective broadcasts.

### CROSS-REFERENCE TO RELATED APPLICATIONS

This application is related to and claims priority to Japanese patent application no. 2007-223451 filed on Aug. 30, 2007, in the Japan Patent Office, and incorporated by reference herein.

### BACKGROUND

1. Field

The present apparatus relates to a broadcast receiving apparatus capable of setting a receiving reservation at one time for a program which is shown or provided several times.

2. Description of the Related Art

Generally, if program information includes a word which is set to be inappropriate, a digital broadcast receiving apparatus does not display the word when the program information is shown. Moreover, a typical data processing apparatus adds a viewing restriction to a broadcast at a receiving apparatus side in order to restrict program outputs. Also, there is a program processing apparatus which prohibits obtaining program data, from a tuner, related to genre information a user does not want to view, based on the genre information.

Furthermore, there is a broadcast receiving apparatus which determines whether a new program is desired by the user or not based on the information with which the user narrows down or selects from the programs and the information of the new program. This broadcast receiving apparatus informs the user if the new program is desired by the user. There also is a program information obtaining apparatus which selects a channel for other service to obtain the program information of the other service while the user is viewing the program corresponding to a keyword related to the program which is set in advance not to be viewed by the user.

Therefore, there is a need for an apparatus and method to reduce burden on a user including required repetition of a receiving reservation which may include a broadcast that the user does not want to receive.

### SUMMARY

The disclosed broadcast receiving apparatus and method enables setting of a receiving reservation at one time for a program shown several times. The broadcast receiving apparatus includes a keyword holding unit which holds a keyword to determine whether or not the program is desired to be received by the user, a program information obtaining unit which obtains the program information of each broadcast before the respective broadcasts of the plurality of the broadcast programs for which the receiving reservation is to be performed are received, a determining unit which determines whether or not the program information of the respective broadcasts obtained by the program information obtaining unit includes the keyword held by the keyword holding unit, and an inhibiting unit which inhibits reception of the respective broadcasts when the determining indicates that the keyword is included in the program information of the respective broadcasts.

Additional aspects and/or advantages will be set forth in part in the description that follows, and in part will become more apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating an outline of a hardware configuration of a personal computer including a broadcast receiving apparatus;

FIG. 2 is a diagram illustrating a hardware configuration of a personal computer including a broadcast receiving apparatus;

FIG. 3 is a diagram illustrating a content of a reservation table;

FIG. 4 is a flow chart illustrating a flow of processing of recording inhibition setting; and

FIG. 5 is a flow chart illustrating a flow of recording starting preprocessing.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

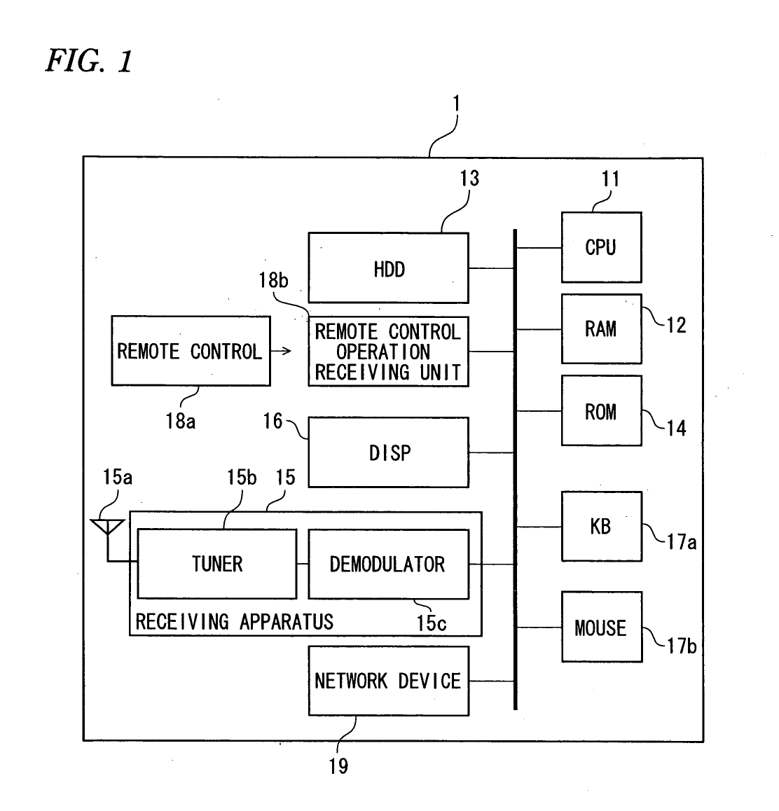

FIG. 1 is a diagram showing an outline of a hardware configuration of a personal computer 1 including a broadcast receiving apparatus according to an embodiment. The personal computer 1 includes a main storage medium such as a CPU (Central Processing Unit) 11, a RAM (Random Access Memory) 12, an auxiliary storage device such as a HDD (Hard Disk Drive) 13, a ROM (Read Only Memory) 14, a receiving apparatus 15, a network device 19, a remote control 18a, a remote control operation receiving unit 18b, a display device such as a display (DISP) 16, a keyboard (KB) 17a, a mouse 17b and the like.

On the HDD 13, an operating system (hereinafter referred to as OS) for managing the system, a device driver which controls a device provided by the personal computer 1 or which is connected to the personal computer 1, an application operated in the personal computer 1, and the like, are installed. Broadcasts are recorded by storing compacted video data which is demodulated from the airwave in the HDD 13.

Furthermore, a TV application is installed on the HDD 13. According to an embodiment, the TV application installed on the HDD 13 is operated at a time set in advance by a user and includes a viewing reservation function which provides the user a view of a television broadcast by displaying the content of a reserved channel via the display 16, and a recording reservation function which records the content of the reserved channel. By processing a signal obtained from the receiving apparatus 15, the CPU 11 performing the TV application displays a video in a window displayed via the display 16 in order to provide the user with a view of the television broadcast. Moreover, the CPU 11 records the television broadcast by storing the signal obtained from the receiving apparatus 15 in the HDD 13.

The remote control 18a may be a so-called infrared remote control, and a corresponding remote control operation receiving unit 18b receives an operational content on the remote control 18a by receiving infrared rays transmitted from the remote control 18a. The user can operate the TV application, call the TV application operated in a background, perform a viewing reservation or a recording reservation, cause the personal computer 1 to switch from a power-saving state, and cause the display 16 to switch from the power-saving state, etc.

The receiving apparatus 15 including an antenna 15a, a tuner 15b, and a demodulator 15c is controlled by the CPU 11 which performs operation(s) including in relation to the device driver. The receiving apparatus 15 receives radio waves using the tuner 15b and selects a channel using the tuner 15b. Based on the radio waves of the channel, the receiving apparatus 15 performs demodulating processing using the demodulator 15c and generating processing of compacted video data streams (TS signals in an embodiment). The generated TS signals are outputted through a bus. The CPU 11 performing the TV application generates a picture of each frame comprising the video based on the TS signal which was outputted from the receiving apparatus 15 (decoding processing). Then an image signal based on the generated picture is outputted to the display 16 and the display 16 displays the image based on the image signal. This makes possible the viewing of the television broadcast.

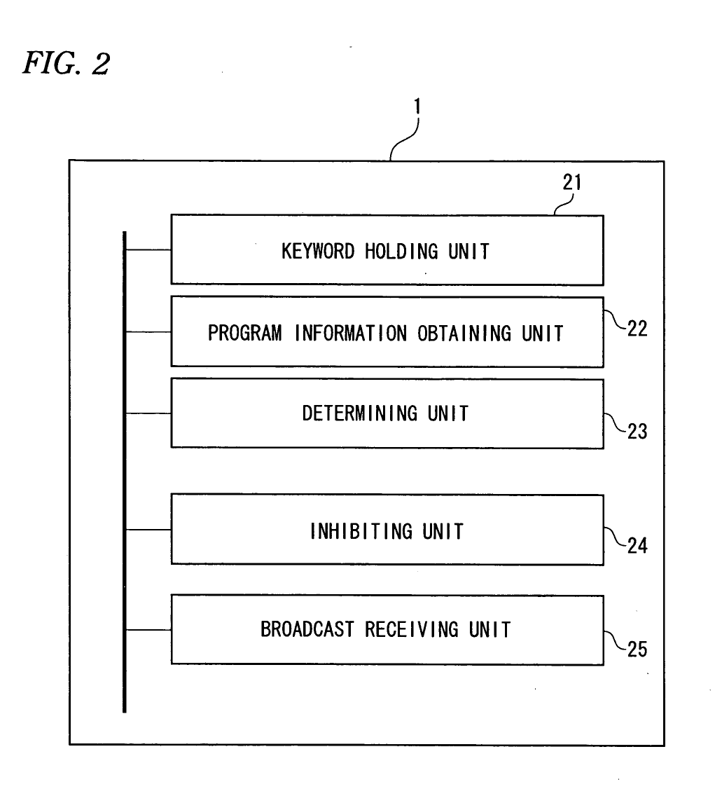

A network device 19 is used when the TV application obtains an electronic program listing through a network. In an embodiment, the TV application obtains the electronic program listing either through the network or the radio waves. Usually, the electronic program listing is regularly obtained by the TV application and then stored in the RAM 12 or the HDD 13. Although at least FIGS. 1 and 2 are described using a personal computer 1, the present invention is not limited to any particular type of computer or device and may be implemented using a specialized terminal, a typical desktop or laptop system, or any apparatus or system enabled to receive a broadcast and information related thereto.

FIG. 2 is a diagram showing an outline of a functional configuration of the personal computer 1 including the broadcast receiving apparatus according to an embodiment. In the personal computer 1 having the hardware configuration shown in FIG. 1, the OS, the device driver, and a display control program which are installed on the HDD 13 are read by the CPU 11 and extracted in the RAM 12. The extracted program is interpreted and each configuration of the personal computer 1 is controlled by performing operations via the CPU 11. As a result, the personal computer 1 works as the broadcast receiving apparatus including a keyword holding unit 21, a program information obtaining unit 22, a determining unit 23, an inhibiting unit 24, and a broadcast receiving unit 25 which is described in detail below. However, the above described each functional unit can be realized respectively, or a plurality of the functional units can be realized all at once by a specific hardware.

The keyword holding unit 21 holds keyword(s) for determining whether or not a program is desired to be viewed by user(s) or to be recorded, by storing the keyword(s) in the HDD 13. That is, in an embodiment, the HDD 13 has stored therein an inhibit keyword table including an inhibit keyword set in advance by a user or viewer. The user registers a keyword, in advance, which are assumed to be included in program information of a program content the user does not want to view or record, such as a cast name, a program content or the like which do not match the user's preference, as the inhibit keyword to the inhibit keyword table. In the inhibit keyword table, the inhibit keyword is included in a so-called plaintext. In an embodiment, the registered keyword is not distinguished as the cast name or the program content. Moreover, in addition to the user's preference, the user can register the keyword, as the inhibit keyword, which is assumed to be included in the program information of the program content the user does not want his/her child to view.

The program information obtaining unit 22 obtains, for example, from an electronic program listing, program information of each broadcast related to viewing or recording out of the plurality of the broadcast programs for which the viewing reservation or the recording reservation is performed. The electronic program listing is usually obtained in advance through the radio waves or the network and is recorded in the RAM 12, the HDD 13 or the like.

The determining unit 23 determines whether or not the inhibit keyword is included in the program information obtained by the program information obtaining unit 22 using the keyword included in the inhibit keyword table. In an embodiment, the program information includes the content information and the cast information in so-called plaintext. Therefore, it is possible to search the program information by a character string using the inhibit keyword which is also held in plaintext.

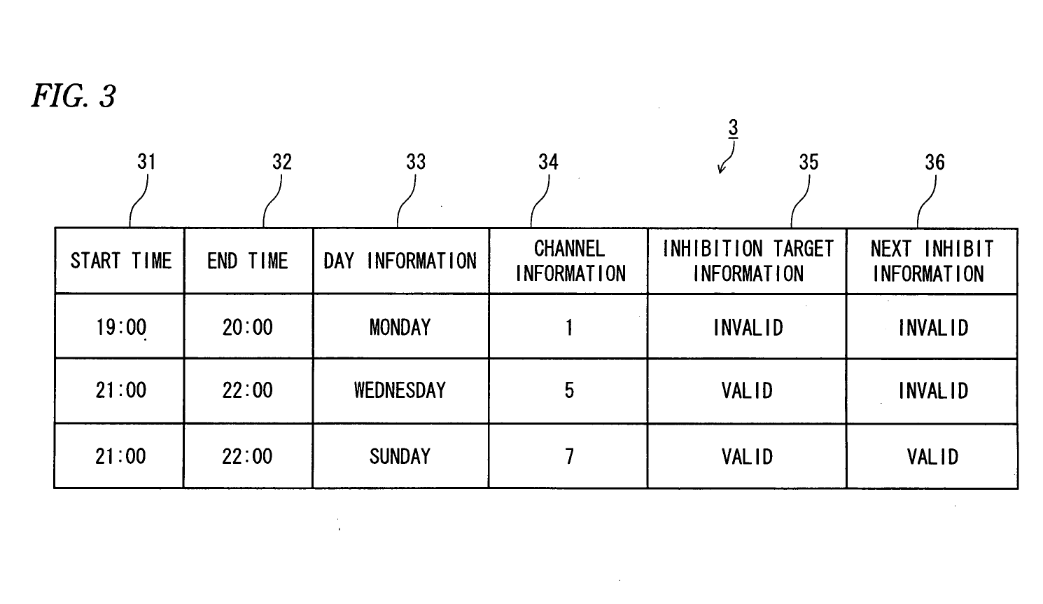

When the determining unit 23 determines that the inhibit keyword is included in the program information, the inhibiting unit 24 inhibits the reception of a corresponding program. In an embodiment, next inhibit information 36 in a reservation table 3 (FIG. 3) described in detail below is used to inhibit the reception of the program. A specific method for inhibiting the reception using the next inhibit information 36 is described below.

The broadcast receiving unit 25 has a function for allowing the user to view a TV program by receiving the radio waves to display an image in the display 16 and for recording the TV program by recording the compacted video data in the HDD 13. That is, the broadcast receiving unit 25 corresponds to the CPU 11 performing the TV application and the receiving apparatus 15 controlled by the CPU 11. Moreover, the broadcast receiving unit 25 can set the receiving reservation at one time for the program shown several times.

FIG. 3 is a diagram showing content of the reservation table 3 related to an embodiment. The reservation table 3 stores reservation information including at least a start time 31, an end time 32, day information 33, channel information 34, inhibition target information 35, and next inhibit information 34. The TV application plays or records the program from the start time 31 to the end time 32 on the day specified by the day information 33 in a channel specified by the channel information 34. In an embodiment, there are two reservation tables 3. One is the reservation table 3 for the viewing reservation and the other one is the reservation table 3 for the recording reservation. Each reservation table 3 is formed by the TV application and is recorded in the HDD 13. In an embodiment, the reservation table 3 for the recording reservation and the reservation table 3 for the viewing reservation are different, but the recording reservation and the viewing reservation can be managed by single reservation table 3 by adding the information identify the recording reservation or the viewing reservation into the reservation information.

In this case, the inhibition target information 35 is the information to identify whether or not corresponding reservation information is a target of inhibiting processing related to an embodiment. The information indicating “valid” or “invalid” is set to the inhibition target information 35. The TV application outputs a dialog such as “Do you inhibit the viewing (or the recording) of the broadcast including the inhibit keyword?” or the like at a time when the user sets the reservation. Thus, the user selects whether or not to perform the inhibiting processing of viewing or recording using the mouse 17a or the like. If the user selects to perform the inhibiting processing, the information indicating “valid” is set to the inhibition target information 35. If the user selects not to perform the inhibiting processing, “invalid” is set to the inhibition target information 35.

Furthermore, the next inhibit information 36 is information indicating “viewing the next broadcast or not recording” on the program related to the corresponding reservation information. The next inhibit information 36 is set to the information indicating “valid” or “invalid”. The next inhibit information 36 is initialized to “invalid” at the time the reservation is performed by the user and the reservation information is generated.

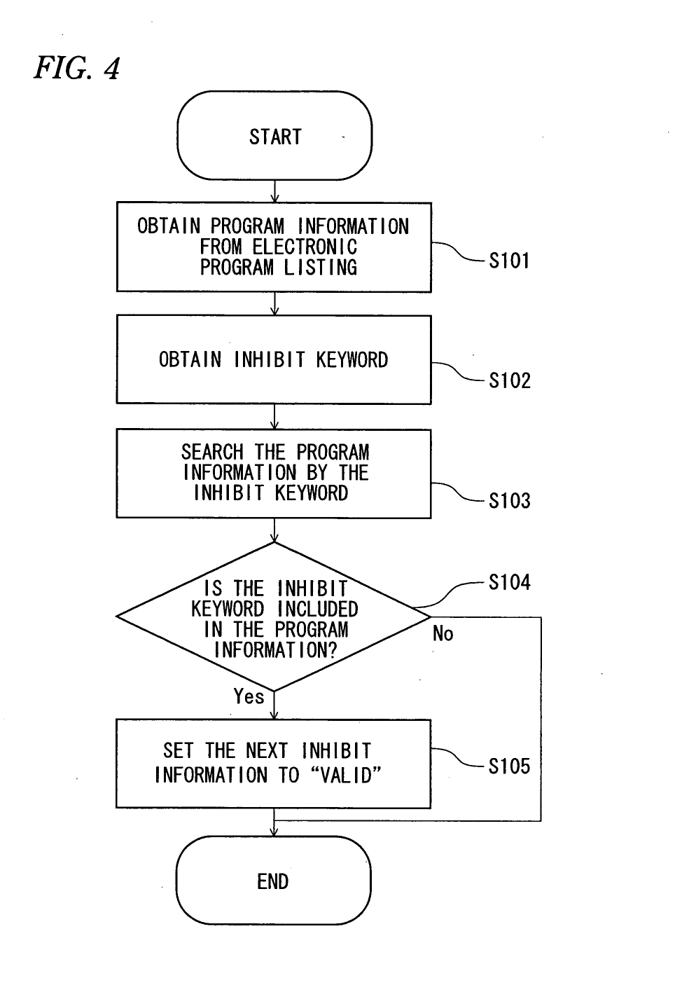

FIG. 4 is a flow chart showing a flow of processing of recording inhibition setting related to an embodiment. By timer-setting of a system, the processing shown in the present flow chart is started a certain time period (e.g., five minutes before) before a recording start time 31 which is set by the user. The timing at which the processing shown in the present flow chart is started can be set appropriately in each embodiment if the processing shown in the present flow chart can be finished by the recording start time 31.

Furthermore, in an embodiment, the processing shown in the present flow chart is performed only on the reservation in which the inhibition target information 35 of the corresponding reservation information is set to “valid”. This can avoid performing the inhibition of the recording on the reservation in which the inhibition target information 35 is set to “invalid”, that is, the reservation in which the user selects not to perform the inhibiting processing.

In operation S101, the program information is obtained. The program information obtaining unit 22 reads the electronic program listing, which has already been obtained through the radio waves or the network, from the RAM 12, the HDD 13 or the like. Then, from the electronic program listing, the program information including the content information and the cast information of the program which is about to be recorded is obtained. However, the electronic program listing which has already been obtained is not used. The electronic program listing can be obtained from outside (a source) every time the processing of the recording inhibition setting is performed. After that, the process goes to operation S102.

In operation S102, the inhibit keyword is obtained. The determining unit 23 obtains the inhibit keyword by reading, from the HDD 13, the inhibit keyword table in which the user has registered the keyword in advance to specify the program that does not match the user's preference. After that, the process goes to operation S103.

Subsequently, in operation S103 and operation S104, it is determined whether or not the inhibit keyword is included in the program information which is scheduled to be recorded. The determining unit 23 searches the program information (including the content information and the cast information) obtained in operation S101 using the keyword registered in the inhibit keyword table obtained in operation S102. That is, soon after that, it can be determined that the program which is scheduled to be recorded does not match the user's preference (the user does not want to record) if the keyword registered in the inhibit keyword table is included in the content information or the cast information which is read. If it is determined that the inhibit keyword is included in the program information, the process goes to operation S105. If it is determined that the inhibit keyword is not included in the program information, the process shown in the present flow chart is ended.

In operation S105, the recording inhibition setting is performed. The inhibiting unit 24 sets the next inhibit information 36 of the corresponding reservation information in the reservation table 3 to “valid”. After that, the process shown in the present flow chart is ended.

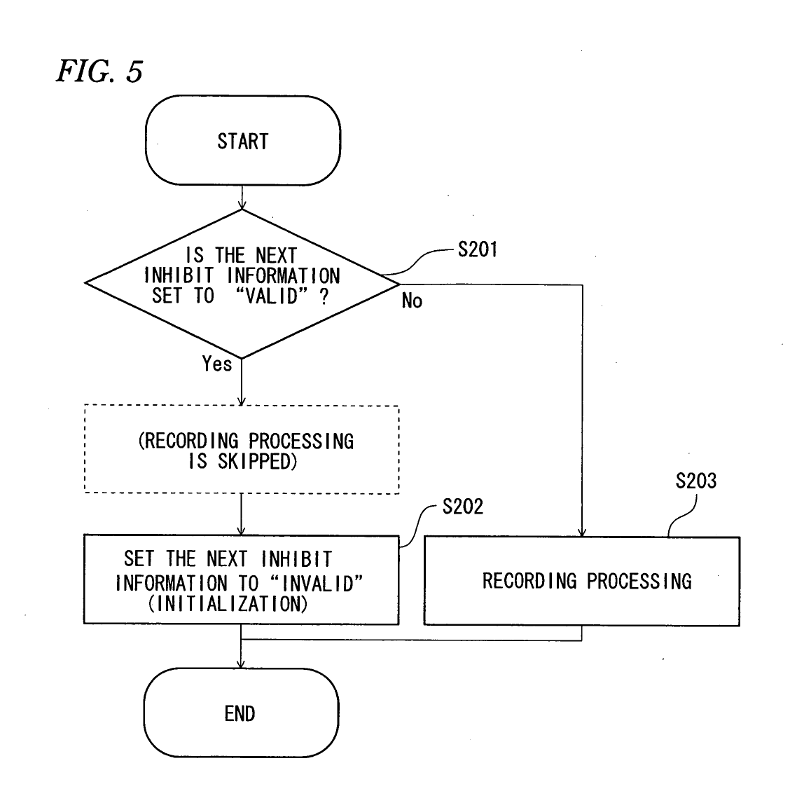

FIG. 5 is a flow chart showing a flow of record starting preprocessing according to an embodiment. The processing shown in the present flow chart is started at a certain time period (e.g., three minutes) before a set time of a recording reservation. However, the timing at which the present processing is started can be set appropriately in each embodiment when the timing comes after the above described processing of the recording inhibition setting and before the recording start time 31.

In operation S201, a setting state of the next inhibit information 36 is confirmed. The inhibiting unit 24 obtains the next inhibit information 36 of the corresponding reservation information in order to determine whether or not the information is set to “valid”. If it is determined that the next inhibit information 36 is set to “valid”, the process goes to operation S202. If it is determined that the next inhibit information 36 is not set to “valid” (set to “invalid”), the process goes to operation S203.

In operation S202, the next inhibit information 36 is initialized. Here, recording processing is skipped because the next inhibit information 36 is determined to be set to “valid” in operation S201. That is, the program is not recorded if the program is related to the reservation information in which the next inhibit information 36 is set to “valid” after it is determined that the inhibit keyword is included in the program information by the processing of the recording inhibition setting. By setting the next inhibit information 36 of the reservation information to “invalid”, the inhibiting unit 24 initializes the next inhibit information 36, at operation S202. As a result, it is determined whether or not the recording is inhibited with respect to the next (e.g., the next week) broadcast in the processing of the recording inhibition setting. After that, the process shown in the present flow chart is ended.

In operation S203, the recording is performed in accordance with the content of the reservation setting. The broadcast receiving unit 25 performs the recording by storing, in the HDD 13, the compacted video data, which is received, modulated and outputted by the receiving apparatus 15. After that, the process shown in the present flow chart is ended.

According to an embodiment, if a keyword for identifying a program which is not desired by the user to be recorded is set in advance, the user can record only the broadcasts automatically excluding the broadcast which is not desired by the user to record simply by setting a repeating recording. That is, according to the broadcast receiving apparatus, it is possible to reduce a burden on a user which had to be done conventionally, such as checking the program content before each recording, and to save the storage area of the HDD 13 necessary for recording.

The flow of processing in the case of the recording reservation of the program shown several times is described using the FIG. 4 and FIG. 5. The entire flow is the same as that in the case of the viewing reservation of the program shown several times. Since processing of viewing inhibition setting (same as the processing of the recording inhibition setting shown in FIG. 4) and viewing starting preprocessing (same as the recording starting preprocessing shown in FIG. 5) are performed on the viewing reservation, it is possible to prevent the user from performing an operation for switching the channels because the program that the user does not want to view is shown in the display 16, or to avoid interrupting the user's other operation. Moreover, when the personal computer 1 is not in an operating state, the operation of the personal computer 1 is inhibited. Accordingly, the power-saving effect can be achieved.

In the above described embodiment, the present apparatus was described as the personal computer 1 including the receiving apparatus 15. However, the present apparatus is applicable as a TV receiver, a recorder such as a so-called hard disk recorder, a specialized apparatus, or any device enabled to receive a broadcast and information related thereto.

Furthermore, in at least one of the above described embodiments, it is determined whether or not the processing of the recording inhibition setting is performed on the reservation by inquiring the user at the time of setting the reservation in order to set the inhibition target information 35 regardless of the genre of the program which is to be a target of the receiving reservation. However, the processing of the recording inhibition setting can be automatically performed on the programs of a certain genre (e.g., variety programs). Specifically, a genre of program is obtained from the electronic program listing or the like and is determined to be or not to be a target of the processing of the recording inhibition setting set in advance. Thus, it can be determined whether or not the processing of the recording inhibition setting is performed in each broadcast. This makes it possible to prevent that viewing or recording of the genre of the program (e.g., news and the like) the user wants to view is automatically inhibited even though the inhibit keyword is included.

Although a few preferred embodiments have been shown and described, it would be appreciated by those skilled in the art that changes may be made in these embodiments without departing from the principles and spirit of the invention, the scope of which is defined in the claims and their equivalents.

What is claimed is:

1. A broadcast receiving apparatus setting a receiving reservation at one time for a program shown several times, the broadcast receiving apparatus comprising:
a keyword holding unit that holds a keyword for determining whether or not a program is desired to be received by a user;
a program information obtaining unit that obtains program information of respective broadcasts before the respective broadcasts of a plurality of the broadcast programs for which a receiving reservation is to be performed are received;
a determining unit that determines whether or not the keyword held by the keyword holding unit is included in the program information of the respective broadcasts obtained by the program information obtaining unit; and
an inhibiting unit that inhibits reception of the respective broadcasts when the determining unit indicates that the keyword is included in the program information of the respective broadcasts.

2. The broadcast receiving apparatus according to claim 1, wherein, before the respective broadcasts are received, the determining unit determines whether or not the keyword is included in the program information by searching the program information obtained by the program information obtaining unit using the keyword held by the keyword holding unit.

3. The broadcast receiving apparatus according to claim 1, wherein the inhibiting unit inhibits displaying processing of the respective broadcasts when the receiving reservation is a viewing reservation and inhibits recording processing when the receiving reservation is a recording reservation.

4. A receiving inhibit method performed by a computer having a broadcast receiving unit setting a receiving reservation at one time for a program shown several times, the method for inhibiting receiving comprising:
obtaining program information of respective broadcasts before the respective broadcasts of a plurality of broadcast programs for which the receiving reservation is to be performed are received;
determining whether or not a keyword is included in the program information of the respective broadcasts obtained; and
inhibiting reception of the respective broadcasts when the determining indicates that the keyword is included in the program information of the respective broadcast.

5. A computer-readable storage medium storing a receiving inhibit program that operates a computer including a broadcast receiving unit setting a receiving reservation at one time for a program shown several times, the program comprising:
obtaining program information of respective broadcasts before the respective broadcasts of a plurality of broadcast programs for which the receiving reservation is to be performed;
determining whether or not a keyword is included in the program information of the respective broadcasts obtained; and
inhibiting reception of the respective broadcasts when the determining indicates that the keyword is included in the program information of the respective broadcasts.

6. A method of setting a receiving reservation for a program, comprising:
obtaining information of a program indicated in a request prior to broadcast of the program;
determining whether the information contains a keyword indicated in the request based on a search of the information; and
inhibiting reception of said program when said determining indicates that the keyword is contained in the information of the program.
